(19) United States
(12) Patent Application Publication
(10) Pub. No.: US 2003/0228969 A1
(43) Pub. Date: Dec. 11, 2003

(54) METHOD FOR SYNTHESIZING ZEOLITE MEMBRANES

(76) Inventors: Junhang Dong, Los Lunas, NM (US); Michael Z. Hu, Knoxville, TN (US); Edward A. Payzant, Oak Ridge, TN (US)

Correspondence Address: UT-Battelle, LLC, 111 Union Valley Rd., PO Box 2008, Mail Stop 6498, Oak Ridge, TN, 37831, US

(21) Appl. No.: 10/166,972

(22) Filed: Jun. 11, 2002

(51) Int. Cl. B01J 20/28

(52) U.S. Cl. 502/4

(57) ABSTRACT

The present invention is a method for synthesizing zeolite membranes, particularly a method for synthesizing supported zeolite membranes by wet gel crystallization in a vapor-phase. The method of the present invention is a method for synthesizing zeolite membranes comprising the steps of first coating a support surface with a wet gel precursor sol to form a uniform layer of the precursor sol on the support surface. The wet gel precursor sol comprises a silicate or aluminosilicate species and a template or structure-directing agent. Then, placing the coated support in a timely manner within a closed vessel containing a sufficient volume of a structure-directing agent so to avoid complete vaporization and to maintain a vapor-liquid coexisting state within the closed vessel under increased temperature and autogenous pressure wherein the support is placed above the liquid surface of the structure-directing agent in a distance that ensures no direct contact between the support and the structure-directing agent throughout the synthesis process and placing the support in a timely manner within the closed vessel so to prevent the wet gel precursor sol from absorbing CO₂ from air. Then, thirdly, heating the closed vessel at a sufficient synthesis temperature for a sufficient time to convert the wet gel precursor sol to a polycrystalline zeolite membrane in the vapor-phase of the structure-directing agent within the closed vessel.

The invention was made with government support under contract no. DE-AC05-960R22464 awarded by the United States Department of Energy to Lockheed Martin Energy Research Corporation; and the government has certain rights in the invention.

### FIELD OF THE INVENTION

The present invention relates to a method for synthesizing zeolite membranes, particularly a method for synthesizing supported zeolite membranes by wet gel crystallization in a vapor-phase.

### BACKGROUND OF THE INVENTION

Supported polycrystalline zeolite membranes have been an active area of research for over a decade because of the increased interest in using these membranes in chemical reaction and separation processes. There has been a major focus on MFI-type zeolite membranes, particularly ZSM-5 and silicalite-1 membranes, because of their readiness to form polycrystalline films on different substrates. Supported MFI-type zeolite membranes have important potential applications in gas separation and membrane reactors because of their excellent performance in hydrocarbon separations and their high thermal and chemical stabilities and potential applications in membrane reactors. For industrial application, zeolite membranes must possess good selectivity and high flux. However, industrial applications of zeolite membranes have been hindered due to some major disadvantages associated with current synthesis techniques that make large-scale production difficult and expensive. At present, zeolite membranes are synthesized by liquid-phase hydrothermal treatment, including in situ crystallization and seeding/secondary growth methods and the vapor-phase transport (VPT) method. The hydrothermal method has major drawbacks of poor reproducibility, bulky consumption of valuable chemicals and large waste volumes. The VPT method has the main problems of low compactness of the zeolite film resulting from the dry gel conversion mechanism and utilization of nerve-damaging amines as structure-directing agents.

In the in situ crystallization method, one side of the substrate surface contacts an aluminosilicate-template synthesis sol or solution. During the early stage of hydrothermal treatment, a discrete layer of zeolite nuclei is formed on the support surface by heterogeneous nucleation and/or deposition of nuclei from the bulk liquid. The crystal nuclei continue to grow into an interlocked polycrystalline film with minimized intercrystal gaps. In seeding/secondary growth synthesis, small zeolite crystallites are pre-embedded in the support surface. The seeded surface is then brought into contact with a synthesis sol or solution under hydrothermal conditions to allow the crystallite seeds further growth into a continuous film. The various liquid-phase hydrothermal synthesis methods offer the advantages of a highly compact zeolite layer (minimized nonzeolitic gaps), short synthesis time (several hours), and better understanding of the crystallization process since they are similar to the traditional processes for zeolite particle synthesis. The main drawbacks of these methods are difficulty in assuring the uniformity of the crystallization conditions and limited reproducibility of high quality membranes; and significant consumption of valuable chemicals such as tetrapropylammonium hydroxide (TPAOH), resulting in large waste volumes and high processing costs.

In the VPT synthesis, the substrate surface is first coated with an aluminosilicate gel layer having a carefully controlled alkalinity and Si/Al ratio. The coated gel layer is dried, then converted to zeolite by contact with vapor phases of liquid mixtures containing water and organic compounds, such as the commonly used mixture of water, ethylenediamine (EDA) and triethylamine (TEA). The VPT process is carried out at an elevated temperature, normally in the range of 170-200° C., and requires a long synthesis time, which varies from a couple of days to longer than a week to complete the crystallization. Important advantages of the VPT method include a well-controllable precursor coating process that can avoid uncovered area in the synthesized zeolite film; a significant reduction in the consumption of valuable organic compounds (because the liquid phase is uncontaminated and can be reused directly); and minimized generation of waste byproducts.

The mechanism of zeolite film formation by the VPT method is not clear but is considered to be quite different from that of the hydrothermal synthesis. In the VPT synthesis, crystallization is dominated by a dry-gel—crystallization mechanism. Although in the conventional VPT method, there may also be a small amount of tiny liquid puddles scattered in the coated precursor layer due to capillary condensation, re-construction of the dry gel network is difficult because the mobility of the precursor species is limited in the strong solid structure. This is evidenced by the much higher activation energy of ZSM-5 zeolite formation from amorphous dry gels (80 kJ/mol) than that of silicalite crystallization from an aqueous solution (40 kJ/mol). Therefore, the compactness of the resulting zeolite film is largely determined by the original packing density of the gel particles. Therefore, the VPT-derived zeolite membranes are likely to be less compact than membranes synthesized via hydrothermal treatments. Moreover, the structure-directing agents used in conventional VPT synthesis, including EDA and TEA, are highly hazardous to the human nervous system and may be a source of safety and environmental concerns.

### OBJECTS OF THE INVENTION

Accordingly, it is an object of the present invention to provide a method for synthesizing supported zeolite membranes that offers good controllability of the synthesis process to provide good reproducibility.

It is another object of the present invention to provide a method for synthesizing supported zeolite membranes that eliminates macro-defects of the zeolite.

It is still another object of the present invention to provide a method for synthesizing supported zeolite membranes that are highly compact with minimized intercrystal gaps and cracks.

It is yet another object of the present invention to provide a method for synthesizing supported zeolite membranes that minimizes waste production.

It is a further object of the present invention to provide a method for synthesizing supported zeolite membranes that significantly reduces consumption of valuable chemicals.

It is yet a further object of the present invention to provide a method for synthesizing supported zeolite membranes that utilizes less toxic compounds thereby eliminating the use of highly hazardous amines.

Further and other objects of the present invention will become apparent from the description contained herein.

### SUMMARY OF THE INVENTION

In accordance with one aspect of the present invention, the foregoing and other objects are achieved by a method for synthesizing zeolite membranes comprising the step of first coating a support surface with a wet gel precursor sol to form a uniform layer of the precursor sol on the support surface. The wet gel precursor sol comprises a silicate or aluminosilicate species and a template or structure-directing agent. Secondly, placing the coated support in a timely manner within a closed vessel containing a sufficient volume of a structure-directing agent so to avoid complete vaporization and to maintain a vapor-liquid coexisting state within the closed vessel under increased temperature and autogenous pressure wherein the support is placed above the liquid surface of the structure-directing agent in a distance that ensures no direct contact between the support and the structure-directing agent throughout the synthesis process and placing the support in a timely manner within the closed vessel so to prevent the wet gel precursor sol from absorbing CO₂ from air. Then, thirdly, heating the closed vessel at a sufficient synthesis temperature for a sufficient time to convert the wet gel precursor sol to a polycrystalline zeolite membrane in the vapor-phase of the structure-directing agent within the closed vessel.

### BRIEF DESCRIPTION OF THE DRAWINGS

In the drawings:

FIG. 1 is a schematic showing the α-alumina disc mounted in the autoclave.

FIG. 2 shows XRD patterns of the membranes after treatment in different vapor phases: A—treated in vapor of 1 M TPAOH aqueous solution; B—treated in vapor of EDA/TEA/water mixture; C—treated in water vapor.

FIG. 3 shows XRD patterns of the materials synthesized from the TPA⁺-free wet gel and the standard patterns of cubic NaP and cubic ANA zeolites. A: Na-P1 film synthesized in the vapor of TPAOH solution; B: ANA-c film synthesized in the vapor of the EDA/TEA/water mixture.

FIG. 4 is a schematic showing of the wet gel layer loaded on the porous α-alumina support.

FIG. 5a is a SEM image of the surface of an MFI zeolite membrane synthesized in vapor of the TPAOH solution.

FIG. 5b is a cross-sectional SEM image of an MFI zeolite membrane synthesized in vapor of the TPAOH solution.

FIG. 6 is a cross-sectional SEM image of the MFI zeolite membrane synthesized in the vapor of EDA/TEA/water mixture.

For a better understanding of the present invention, together with other and further objects, advantages and capabilities thereof, reference is made to the following disclosure and appended claims in connection with the above-described drawings.

### DETAILED DESCRIPTION OF THE INVENTION

Zeolites are crystalline aluminosilicates having defined, uniform lattice and pore structures. Zeolites have as a fundamental unit a tetrahedral complex consisting of Si⁺⁴ and Al³⁺ in tetrahedral coordination with four oxygen atoms. Those tetrahedral units of (SiO₄) and (AlO₄)⁻ are linked to each other by shared oxygen atoms to form three-dimensional networks. The building of such networks produces channels and cavities of molecular dimensions. Water molecules and charged compensating cations are found inside the channels and cavities of the zeolitic materials. The various possible linkages between the primary tetrahedral structure determine a multitude of zeolite structures, containing different surface areas, pore sizes and pore shapes. The diameters of these pores lay in the range of small and medium size molecules. Besides silicon and aluminum, other atoms can be incorporated into lattice positions. Depending on their electrical charge, the lattice is neutral or negatively charged (e.g., one negative charge per aluminum). This lattice charge can be compensated by cations, which are quite mobile in the pores. Usually, sodium ions are present after the synthesis of zeolites. They can be exchanged by other cations, e.g., protons, thus creating acid sites in the zeolite. If transition metals are incorporated into the zeolite lattice, redox properties are induced in this zeolite-like material.

The structure of zeolites is what gives them unique qualities. Synthetic zeolites are used, for example, as adsorbents in separation processes, as replacements for phosphates in detergents, and as components in catalysts in the petrochemical industry for converting hydrocarbons into other useful products. The porous structure of the zeolite allows different sized molecules to enter the pores, and the hydrophobic or polar interactions with those molecules act as a catalyst in that molecule's conversion to another useful target compound, either through rearrangement, addition, or extraction reactions. A larger pore might have a stronger affinity for larger chain hydrocarbons or highly branched hydrocarbons, for example, while small pores may have a higher affinity for smaller molecules such as water or ions. Thus, the pore size or cavity size in combination with acidity can alter the catalytic properties of the zeolite. The physicochemical properties of zeolites are strongly influenced by the zeolite's chemical composition. Aluminosilicate zeolites are very stable under humid conditions.

The various stoichiometries of SiO₂, Al₂O₃, and other oxides lead to various zeolites. One such zeolite that is of great interest is called Zeolite Socony Mobil-5 (SM-5), or ZSM-5. The ZSM-5 zeolite is a supported, MFI-type zeolite. The final structure of a ZSM-5 zeolite has a lattice configuration, which encompasses three basic functional groups: Al₂O₃ and SiO₂ and Na₂O. Thus, ZSM-5s are often described in terms of these functional groups and their relative ratios within the zeolite lattice. The ratios of these groups, especially the SiO₂/Al₂O₃ molar ratio, are an important indicator of the useful properties the zeolite will possess. For instance, for catalytic cracking operations, zeolites are most useful with a range of 15-150 SiO₂/Al₂O₃ molar ratio. Acid resistance and thermal stability also increase as this ratio increases. On the other hand, for adsorption and cation exchange uses, a decrease in the SiO₂/Al₂O₃ molar ratio increases the efficiency due to an increase in cations in the zeolite lattice.

Along with changing the SiO₂/Al₂O₃ molar ratio, control of the pore size and the general lattice structure of zeolites are often accomplished by use of templates such as tetrapropylammonium (TPA) salts. Zeolites prepared using an organic template are common, and generally have SiO₂/Al₂O₃ molar ratios of at least 60, and frequently greater. ZSMs can also be made using an inorganic base such as NaOH. Using NaOH, a SiO₂/Al₂O₃ molar ratio ranging from 20 to 30, have been achieved. Further, the inorganic cations present influence the zeolite lattice framework and useful properties. While cations are necessary for charge balance, the identity of the cation can be chosen to tailor the zeolite. For ZSM-5 zeolites, Ba, Na, K, Li, Cs, NH₃⁺ and mixtures thereof can be used.

The present invention is a new method of vapor-phase treatment of a template-containing wet gel layer developed for the synthesis of supported MFI-type zeolite membranes on a solid support such as porous α-alumina supports. The modified vapor-phase method of the present invention utilizes tetrapropylammonium hydroxide (TPAOH) as the structure-directing agent and can combine the advantages but avoiding the disadvantages of the conventional hydrothermal and VPT methods.

The method of the present invention comprises two major steps. The first step comprises pre-loading a thin wet gel layer of silicate-TPA⁺ (tetrapropylammonium) or aluminosilicate-TPA⁺ precursor on a porous support surface by the well-controllable dip-coating or slip-casting technique. The parental synthesis sol is prepared by dissolving fumed SiO₂ in a TPAOH solution with its pH controlled by addition of sodium hydroxide (NaOH). An aluminum source may be introduced to the parental sol to obtain a suitable Si/Al ratio for zeolite membrane synthesis on inert, non-alumina substrates. The support surface contacts the synthesis sol for a sufficient time to coat a uniform wet gel precursor layer on the support surface. The coated solid is immediately sealed in an autoclave or other closed vessel, on a Teflon support to prevent the loaded precursor from absorbing CO₂ from air. The TPAOH is used as a template or structure-directing agent. Other templates or structure-directing agents that can be used include TPABr and a mixture of ethylenediamine (EDA)/triethylamine (TEA)/water.

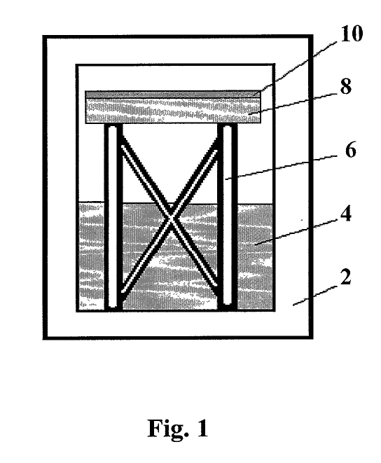

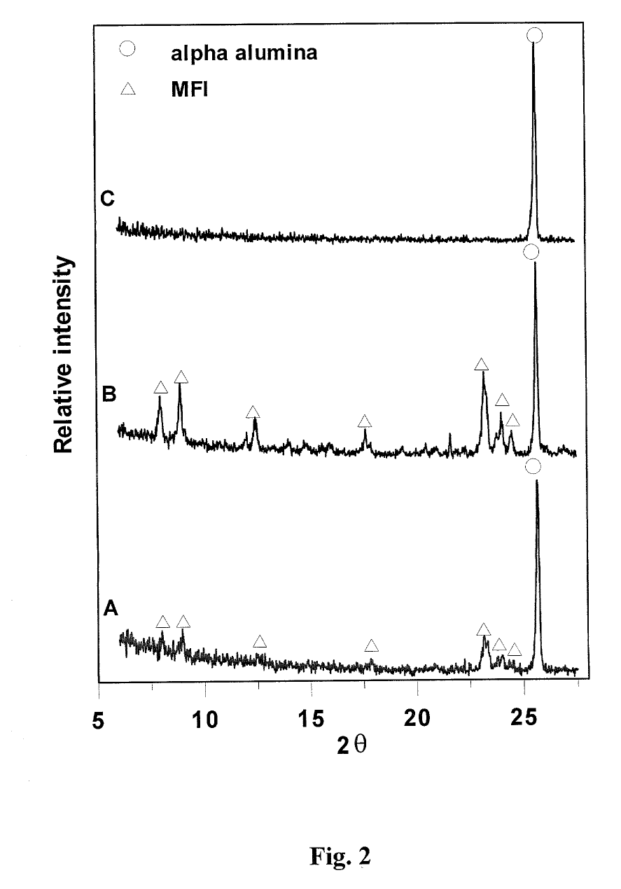

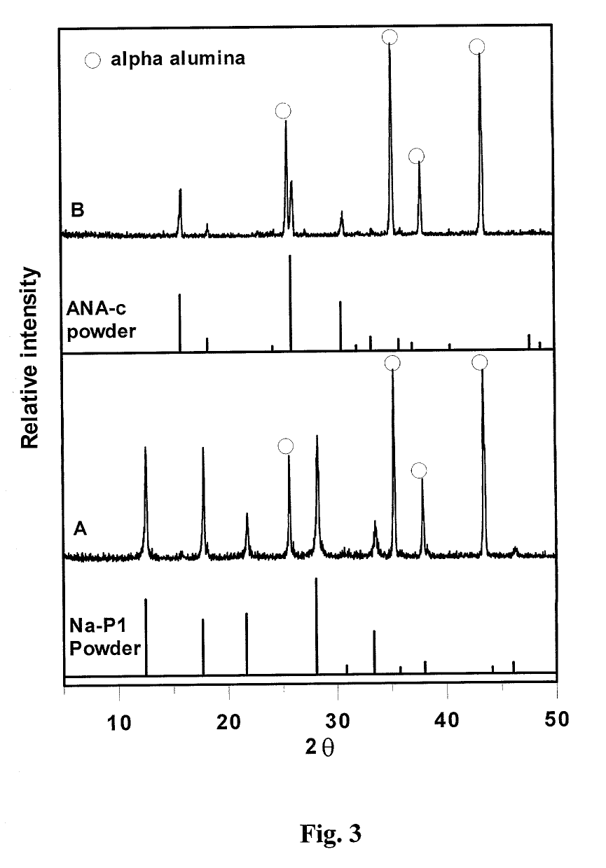

The second step is performed immediately after the first step without drying the gel. The second step converts the amorphous gel layer to a polycrystalline zeolite film in the vapor-phase of the TPAOH solution. The vapor phase is provided by the 1 M TPAOH aqueous solution, which has never been used in the conventional VPT synthesis. The TPAOH was used as the structure-directing agent because it is the most effective template for formation of MFI-type zeolites; and, it is less toxic than the commonly used amines. FIG. 1 depicts the position of a macroporous alumina disc 8 having a coating of wet gel precursor layer 10, mounted in an autoclave 2. The coated solid 8 is located above the liquid level 4 in a distance that ensures no direct contact between the solid 8 and the liquid 4 throughout the synthesis process. The liquid volume 4 in the autoclave 2 is large enough to avoid complete vaporization and maintain a certain liquid volume under the synthesis temperature and autogenous pressure. The coated alumina disc 8 is suspended above the liquid 4 by a Teflon stand 6 to ensure that no direct contact between the liquid 4 and the solid 8 occurs. After being placed at room temperature for 20-30 minutes to allow the remaining liquid to completely soak into the support pores, the autoclave is moved into the oven, which is preheated to 190° C., for vapor-phase treatment. The synthesis temperature is in the range from about 170° to 200° C. and the synthesis time ranges from about 2 to 6 days. The membrane is washed and dried after the vapor-phase treatment and calcined at 400° C. to 500° C. for membrane activation prior to practical use. The X-ray diffraction (XRD) pattern and the electron scanning microscopy (SEM) pictures of the synthesized MFI membranes are shown in FIG. 2 and FIG. 3. Other liquids including a mixture of EDA/TEA/water with a mole composition of 8.1% EDA/30.7% TEA/61.2% H₂O and the pure water were also used as vapor sources to investigate the effects of the vapor phase on the zeolite crystallization.

The following examples demonstrate the method of the present invention for the synthesis of MFI-type Zeolite membranes. An α-Alumina disc, 22 mm in diameter, 2 mm thick and having an average pore size of about 0.19 μm, was used as a substrate. The side of the disc for membrane coating was polished with #600 sandpaper, washed with deionized water, and dried at 50° C. overnight before use. Other chemicals used in the Examples included fumed silica (>99.99%, Aldrich), tetrapropylammonium hydroxide (TPAOH) (1 M solution, Aldrich), sodium hydroxide (>99.99%, Aldrich), ethylenediamine (EDA) (>99%, Adrich), triethylamine (TEA) (>99%, Aldrich), and helium (>99.99%, Wright Bro., Ohio). All the chemicals were used as received.

### EXAMPLE 1

The synthesis sol was prepared using 0.33 g NaOH pellets dissolved in 16.7 ml of 1 M TPAOH aqueous solution. The solution was then heated to 80°-90° C. under rigorous stirring. Then 3.33 g fumed silica was added into the solution with strong stirring until the system became visually transparent. The overall mole composition of the resulting synthesis sol was 7.0% SiO₂, 0.8% NAOH, 2.1% TPAOH, and 90.1% H₂O. The synthesis sol was aged for 3 hours at room temperature in a capped Teflon flask. The polished side of the disc was dipped in the sol for 5-12 seconds to coat a uniform precursor layer. Then the disc was placed coated-side-up on a Teflon stand in a stainless steel autoclave. The autoclave had an inner diameter of 25 mm and an inside height of 65 mm, providing a capacity of about 32 ml. The liquid volume in the autoclave was large enough (−15 ml) to avoid complete vaporization and to maintain a vapor-liquid coexisting state in the autoclave under the synthesis temperature and autogenous pressure. The disc was kept 2 cm above the liquid level before being heated. FIG. 1 depicts the position of the alumina disc mounted in the autoclave. The autoclave was sealed immediately after the disc was mounted to prevent the loaded precursor layer from absorbing CO₂ from air. Due to the high viscosity of the synthesis sol, some liquid remained on the surface for 10-15 minutes before being completely soaked up by the substrate. After being placed at room temperature for 20-30 minutes to allow soaking of the remaining liquid into the support pores, the autoclave was moved into the oven, which was preheated to 190° C., for vapor-phase treatment.

The vapor phase was provided by a 1 M TPAOH aqueous solution. The time of vapor-phase treatment was 6 days. After synthesis, the discs were washed several times with deionized water and dried/stored in an oven at 50° C.

### EXAMPLE 2

In this example, the gel coating was made using colloidal silica to study the effect of template in the parental sol on the resultant zeolite structure. The colloidal silica suspension was prepared by adding 3.33 g fumed silica into 17.3 ml of 1.37 M NaOH solution at 80° C. under rigorous agitation. The overall mole composition of the final colloidal system was 7.0% SiO₂, 2.9% NaOH, and 90.1% H₂O. The overall mole fraction of NaOH was determined by equalizing the total molar numbers of the hydroxide group introduced into the colloidal silica system and the silicate-TPA⁺ synthesis sol. The 1 M TPAOH solution and the 8.1% EDA/30.7% TEA/61.2% H₂O mixture were used in the vapor-phase treatment. All the other synthesis conditions were the same as those in EXAMPLE 1.

The crystal structures of the resultant films were identified by X-ray diffraction and the morphology of the top layer was observed by scanning electron microscopy. Pure helium permeation was measured before membrane activation to evaluate the integrity and compactness of the zeolite film. Helium permeation was determined by a transient single-gas-permeation setup. The membranes were further dried at 100° C. for at least 4 hours prior to helium permeation measurement.

X-ray Diffraction (XRD) patterns of the discs after vapor-phase treatment are shown in FIG. 2 and FIG. 3. Table 1 below summarizes the synthesis conditions and results obtained.

TABLE 1
Results of zeolite membrane synthesis under different conditions.

| Expmnt. | Synthesis sol | Liquid phase | T° | Time | Top layer | Thickness | Quality |
|---|---|---|---|---|---|---|---|
| 1 | 7.0% SiO₂ + 2.1% TPAOH + | 1 MTPAOH | 190 | 6 days | MFI | 3 μm | Good |
| | 0.8% NAOH + 90.1% H₂O | | | | | | |
| 2 | 7.0% SIO₂ + 2.1% TPAOH + | EDA/TEA/H₂O | 190 | 6 days | MFI | 12 μm | Poor |
| | 0.8% NAOH + 90.1% H₂O | (8.1/30.7/612) | | | | | |
| 3 | 7.0% SIO₂ + 2.1% TPAOH + | H₂O | 190 | 6 days | Amor- | — | — |
| | 0.8% NaOH + 90.1% H₂O | | | | phous | | |
| 4 | 7.0% SIO₂ + 2.9% NaOH + | 1 M TPAOH | 190 | 6 days | NaP- | — | — |
| | 90.1% H₂O | | | | cubic | | |
| 5 | 7.0% SIO₂ + 2.9% NaOH + | EDA/TEA/H₂O | 190 | 6 days | ANA- | — | — |
| | 90.1% H₂O | (8.1/30.7/612) | | | cubic | | |

For the gel layers coated from the parental synthesis sol containing template TPAOH, the XRD patterns (see FIG. 2) indicate that MFI-type zeolite crystallites have formed on the α-alumina supports after being treated in vapor phases of the TPAOH solution (A) and the EDA/TEA/water mixture (B). However, the gel layer remained in an amorphous phase after treatment in the vapor of the pure water

Interesting results were obtained when the precursor layers were coated from the TPA⁺-free colloidal silica suspension. In this Example, MFI zeolite was not formed in either one of the vapor phases of the TPAOH solution and the EDA/TEA/water mixture. A cubic Na-P1 (GIS) zeolite phase was formed on the support after treatment in the vapor phase of the TPAOH solution and a cubic analcime (ANA) phase was formed in the vapor phase of EDA/TEA/water mixture. FIG. 3 shows that the XRD patterns of the two synthesized materials match perfectly the standard patterns of the cubic Na-P1 and cubic ANA powder, respectively. These indicate that the structure-directing organic molecules play a key role in determining the crystallization of the precursor layer and utilization of template TPAOH in the parent synthesis sol is critical for formation of the MFI zeolite films.

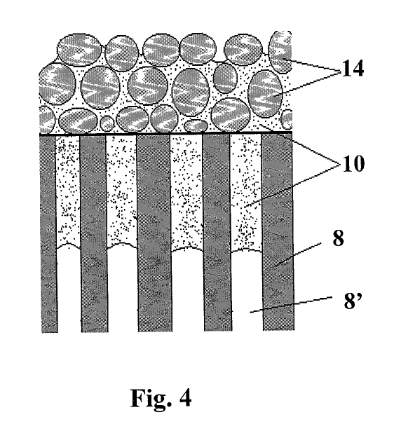

FIG. 4 schematically shows the wet gel precursor layer loaded on the porous α-alumina substrate. A substantial amount of liquid of the synthesis sol 16 was held in the porous structure of the precursor gel layer 10 having precursor gel particles 14, and the macropores 8′ of the α-alumina support 8 after the dip-coating process. Since a liquid phase existed in the autoclave at the synthesis temperature, a significant amount of liquid could be retained in the gel layer throughout the heat treatment because of the capillary condensation effect. When the TPAOH solution or the EDA/TEA/water mixture was used, a certain level of the organic concentration was maintained in the liquid phase of the gel layer by reaching a vapor-liquid equilibrium state with the vapor phase. The large amount of liquid containing template and silicate species in the gel structure not only promoted crystal nucleation, but also helped densify the zeolite film because the ionic precursor species could efficiently diffuse to the crystallite surface, keeping crystal growing to finally close up the intercrystal gaps.

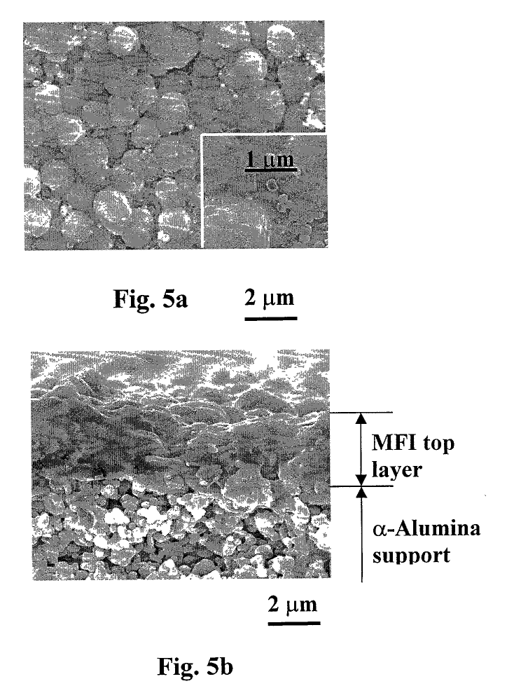

When TPAOH solution was used to provide a vapor phase (Exp. 1 in Table 1), the nucleation and crystal growth mechanism of the wet-gel-vapor-phase treatment is thought to be similar to that of the in situ crystallization method. Zeolite nuclei could form in gel particles and in the liquid phase between the particles as well. The nucleation process could be greatly facilitated by the existence of synthesis solution directly from the aged sol because the pre-assembled organic-inorganic building blocks, which serve as nucleation centers, were preserved in the wet gel. These crystal nuclei were able to grow because the ionic species such as silicate and TPA⁺ were efficiently supplied by the liquid phase in the coated layer. The silicate species in the liquid of the gel pores could come from two sources: the first was that originally dissolved during synthesis sol preparation and the second was the re-dissolution of the solid gel particles in the process of crystallization. The crystallization mechanism of the current vapor-phase treatment method was helpful for increasing the compactness of the zeolite layer because the re-dissolution-crystallization process could completely re-construct the original gel network. Thus, the effect of the packing density of the gel layer on the zeolite film compactness became less significant. In fact, some small zeolite crystals (0.1-0.2 μm) with typical MFI morphology were found on the zeolite film surface as shown in FIG. 5a. This suggests that small liquid puddles existed even at the gel surface during vapor-phase treatment because such small MFI crystals with well-defined morphology were most likely formed in a liquid phase.

FIGS. 5(a) and (b) show SEM images of the zeolite membrane synthesized in the vapor of TPAOH solution. From the SEM pictures, a compact zeolite film composed of inter-grown crystals was observed. The thickness of the zeolite film was estimated to be ˜3 μm based on the SEM observation. The zeolite particle size from the SEM top (surface) view in FIG. 5a was about 1.5-2 μm and had a cauliflower-like structure, which appeared to be polycrystalline particles formed by numerous smaller, inter-grown crystals. This observation of the particle morphology is consistent to those reported in the PVT synthesis where a well-defined single crystal shape is unable to develop because of the mechanism of gel particle crystallization in the absence of a bulk liquid phase. The helium permeance of the membrane before calcination was 3.8×10⁻⁹ mol·s⁻¹·m⁻²·Pa⁻¹, which is less than 0.1% of the permeance through the uncoated α-alumina support (helium permeance 4.1×10⁻⁶ mol·s⁻¹·m⁻²·Pa⁻¹). This indicates that the membrane was of good quality, with minimized macro-defects. FIG. 5b is a cross-sectional view.

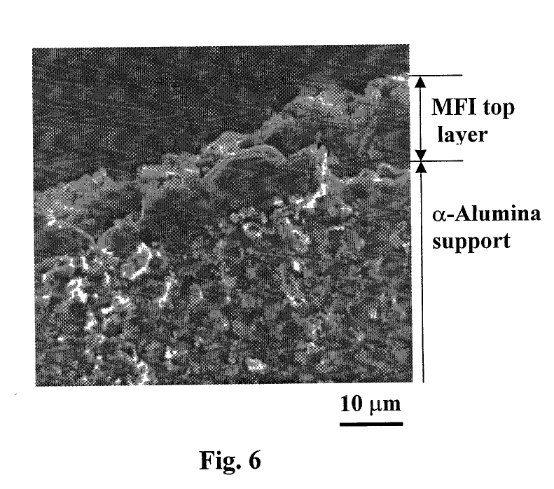

When a mixture of EDA/TEA/water was used as the vapor source (Exp.2 in Table 1), the crystallization and zeolite film formation mechanism appears to have been similar to that when TPAOH solution was used. However, the organic compound in the vapor phase were ETA and TEA instead of TPAOH. In the first stage of vapor-phase treatment, a significant fraction of the TPAOH molecules in the original liquid of the wet gel should be removed via vaporization because both the vapor and liquid phases in the autoclave initially did not contain TPAOH. Meanwhile, EDA and TEA molecules were continuously absorbed/dissolved by the liquid in the wet gel from the vapor phase until a vapor-liquid equilibrium state was reached. The cross-sectional SEM image of the MFI membrane synthesized in the vapor of EDA/TEA/water mixture is shown in FIG. 6. It can be seen from the SEM pictures that the compactness and continuity of the zeolite membrane are not as good as that of the membrane obtained in the vapor of TPAOH solution. Helium permeance of the membrane measured before calcination was 1.9×10⁻⁷ mol·s⁻¹·m⁻²·Pa⁻¹, which was about 5% of the permeance on the uncoated support and was 50 times higher than that of the membrane synthesized in the TPAOH vapor.

Two possible reasons may be responsible for the lower quality of the membrane synthesized in the vapor of EDA/TEA/water. The first is that the two types of organic molecules, i.e. EDA/TEA and TPAOH, may have different effectiveness as promoters for zeolite crystallization due to their different molecular structure, basicity, hydrophilicity, and polarity. TPA⁺ has been demonstrated the most effective template for synthesis of MFI-type zeolites both in the initial nucleation and late crystallization stages. The second is that the silicate-TPA⁺ nucleation centers carried over from the original synthesis sol may be partly disbanded when the TPAOH molecules vaporized from the gel layer, decreasing the population of the crystalline nuclei generated in the early stage.

Results from using pure water as the vapor source and the precursor layer coated from the silicate-TPA⁺ parental sol are also listed in Table 1 as Exp. 3. No zeolite crystalline phase was found by XRD examination after vapor-phase treatment. This result indicates that, under the present synthesis conditions, a vapor phase containing template molecules with an appropriate concentration is necessary for zeolite crystallization. Although the wet gel originally contained silicate-TPA⁺ composites and TPA⁺ ions with concentrations suitable for zeolite formation under hydrothermal condition, a large fraction of the TPAOH molecules necessary for MFI zeolite formation were removed from the gel by vaporization during the process of being heated up to 190° C. The vaporized TPAOH molecules were dissolved into the water phase in the autoclave. It is likely that the pre-organized silicate-TPA⁺ clusters (nucleation centers) were dissociated and the concentration of TPAOH in the liquid of the gel layer became too dilute to effectively serve as structure-directing agent in zeolite crystallization. The result of this experiment is consistent with the literature, which reported that, in many systems, amorphous or dense nonzeolitic materials were formed in the absence of templating agents.

When the precursor layers were obtained from the template-free colloidal silica system, cubic Na-P1 zeolite and cubic ANA zeolite were formed in the vapor phases of the TPAOH solution and the EDA/TEA/water mixture, respectively (Exp. 4 and 5 in Table 1). These results demonstrate that the silicate-TPA⁺ nucleation centers pre-organized during the synthesis sol preparation and preserved in the wet gel thereof play a key role in the crystallization of MFI-type zeolite under the present synthesis conditions.

Although the originally template-free liquid phase of the precursor gel could absorb TPAOH or EDA/TEA molecules from the vapor phase in the process of vapor-phase treatment, these organic molecules were unable to direct an MFI structure during crystallization. A possible reason is the significant change of the Si/Al ratio in the precursor layer during the vapor-phase treatment. Although no aluminum source was introduced to the original sol and the colloidal silica, substantial Al³⁺ could enter the gel layers via dissolution of the alumina support into the highly alkaline liquids. Since NaOH concentration in the colloidal silica (2.9 mol %) was much higher than that in the silicate-TPA⁺ sol (0.8 mol %), much more alumina would be dissolved in the wet gel from the colloidal silica than in the gel from the silicate-TPA⁺ sol.

The Si/Al ratio of the identified Na-P1 and ANA-c zeolite structures were 1.67 and 2.0 respectively, suggesting an Si/Al ratio near the range of 1.6-2.0 was attained in the precursor layers of the colloidal silica due to dissolution of the alumina support. Such a low level of Si/Al ratio is unfavorable for the formation of MFI-type zeolite but favors crystallization of low silica zeolites such as ANA and MOR. According to the Ostward's law of successive transformation, dense phases (structure with small ring numbers such as Na-P1 and ANA) are thermodynamically favored as final results when a long synthesis time is used. These may provide some explanation to the experimental observations here.

Both the Na-P1 (GIS) and ANA structures have ring number of 8 with different secondary building units. Their channel sizes are not big enough to accommodate any of the organic molecules involved in the work of the present invention. This suggests that the currently used organic compounds could not play a templating role in the crystallization of Na-P1 and ANA zeolites. However, these organic molecules may play a role as space-filling agents, which reduce the energy barrier to organization of the zeolite structures. The differences in the molecular geometry, polarity, and hydrophilicity between the TPAOH and EDA/TEA molecules are the reasons that caused the different structures of the zeolites synthesized in their vapor phases. Acidity of the synthesized NaP l zeolite is higher than that of the ANA zeolite as the former has higher Al content in its framework. As expected, the more acidic Na-P1 zeolite was formed in the presence of the more basic TPAOH molecules.

The synthesis method of the present invention is uniquely characterized by a wet gel crystallization mechanism and is unique in that there is no direct contact with a bulk liquid phase. The synthesis method of the present invention comprises two major steps. The first step is to load a thin layer of precursor gel on the surface of the support from an aged synthesis sol containing silica and template TPAOH but free of aluminum. The second step is to convert the amorphous gel layer to an MFI zeolite film by a vapor-phase treatment. The second step was performed immediately after the first step without drying the gel. The MFI membrane synthesized in the vapor of the TPAOH solution was of better quality in terms of zeolite film continuity and compactness than that obtained in the vapor of the EDA/TEA/water mixture. It has also been demonstrated that the silicate-TPA⁺ nucleation centers pre-organized during the synthesis sol preparation and preserved in the wet gel thereof play a key role in the crystallization of MFI-type zeolite under the present synthesis conditions. Cubic Na-P1 zeolite and cubic ANA zeolite crystallites were formed in the vapor phases of the TPAOH solution and the EDA/TEA/water mixture, respectively, when the precursor layers were coated from the template-free colloidal silica system.

Additional embodiments of the present invention include the use of different support geometry such as tubular and honeycombic membrane substrates with the capacity and geometry of the autoclave being changed correspondingly to accommodate the supports. In addition, different materials can be used for the membrane support, such as porous α-alumina, γ-alumina, clay, sintered stainless steel, zirconia, and silica, etc. Different composition of the parental synthesis sol may also be used. The composition of the synthesis sol is adjusted when different support materials are used, such as using relatively high Al/Si ratio aluminosilicate-TPA⁺ sol for non-alumina, inert support materials. TPABr may also be used as the templating (structure-directing) agent in preparation of the synthesis sol. Furthermore, the synthesis method of the present invention can be used to synthesize other types of zeolite membranes, such as FAU-type, MOR-type, P-type, ANA-type and FER-type membranes, using appropriate organic compounds and Si/Al ratios. A multiple coating and vapor-phase treatment may also be used to improve the membrane quality.

The method of the present invention has the advantages of good controllability of the synthesis process. A uniformly coated thin precursor layer is obtained by a dip-coating or slip-casting technique even on complex geometry. The uniformity of the crystallization conditions on the entire precursor layer is assured in a vapor environment at a vapor-liquid state of equilibrium. The method of the present invention provides for high compactness of the synthesized membranes wherein the intercrystal gaps and cracks are minimized. In addition, consumption of valuable organic compounds is significantly reduced. Since the liquid phase in the autoclave or other closed vessel is kept away from the membrane support, contamination is avoided and the liquid phase can be reused directly for multiple times. Furthermore, the volume of the waste byproducts is minimized and the less toxic compound TPAOH can be used as the template instead of the highly hazardous amines, e.g. EDA and TEA, etc. The present invention has important potential for applications in large-scale production of zeolite membranes. The method of the present invention also allows for improved membrane quality with multiple coatings and vapor-phase treatment.

While there has been shown and described what are at present considered the preferred embodiments of the invention, it will be obvious to those skilled in the art that various changes and modifications can be made therein without departing from the scope of the invention defined by the appended claims.

What is claimed is:

1. A method for synthesizing zeolite membranes comprising the steps of:
a.) providing a wet gel precursor sol comprising a silicate or aluminosilicate species and a template or structure-directing agent;
b.) providing a support having a surface;
c.) coating said surface of said support with said wet gel precursor sol to form a uniform layer of said wet gel precursor sol on said surface;
d.) placing said support in a timely manner within a closed vessel having therein a sufficient volume of a structure-directing agent so to avoid complete vaporization and to maintain a vapor-liquid coexisting state within said closed vessel under increased temperature and autogenous pressure, wherein said support is placed above said structure-directing agent within said closed vessel at a distance that ensures no direct contact between said support and said structure-directing agent throughout the synthesis process and placing said support in a timely manner within said closed vessel so to prevent said wet gel precursor sol from absorbing CO₂ from air; and
e.) heating said closed vessel at a sufficient synthesis temperature for a sufficient time to convert said wet gel precursor sol to a polycrystalline zeolite membrane in the vapor-phase of said structure-directing agent within said closed vessel.

2. The method of claim 1 wherein said template or structure-directing agent of step a) is tetrapropylammonium hydroxide (TPAOH), TPABr or ethylenediamine(EDA)/triethylamine(TEA)/water.

3. The method of claim 1 wherein said wet gel precursor sol comprises SiO₂, NaOH, TPAOH and water.

4. The method of claim 3 wherein said wet gel precursor sol has a mole composition of 7.0% SiO₂, 0.8% NaOH, 2.1% TPAOH, and 90.1% H₂O.

5. The method of claim 1 wherein said support is a-alumina, y-alumina, clay, sintered stainless steel, zirconia, or silica.

6. The method of claim 5 wherein said support is an a-alumina disc.

7. The method of claim 5 wherein said support has a support geometry being tubular or honeycombic.

8. The method of claim 1 wherein said structure-directing agent of step d) is TPAOH, TPABr or EDA/TEA/water.

9. The method of claim 8 wherein said structure-directing agent has a mole composition of 8.1% EDA/30.7% TEA/61.2% H₂O.

10. The method of claim 8 wherein said structure-directing agent has a mole composition of 1 M TPAOH.

11. The method of claim 1 wherein said synthesis temperature ranges from about 100° C. to about 300° C.

12. The method of claim 11 wherein said synthesis temperature ranges from about 170° C. to about 200° C.

13. The method of claim 12 wherein said synthesis time ranges from 2 to 6 days.

14. The method of claim 1 further comprising the steps of: a) removing said polycrystalline zeolite membrane from said closed vessel; b) washing said polycrystalline zeolite membrane; c) drying said polycrystalline membrane; and d) calcining said polycrystalline membrane for membrane activation prior to use.

15. The method of claim 14 wherein said membrane is calcined at a temperature ranging from 400° C. to 500° C.
